(19) United States
(12) Patent Application Publication
(10) Pub. No.: US 2008/0052313 A1
(43) Pub. Date: Feb. 28, 2008

(54) Service Bus-Based Workflow Engine for Distributed Medical Imaging and Information Management Systems

(76) Inventor: Ronald Keen, Shelburne, VT (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/466,956

(22) Filed: Aug. 24, 2006

(51) Int. Cl. G06F 17/00

(52) U.S. Cl. 707/104.1

(57) ABSTRACT

A computer-implemented architecture implementing Picture Archiving and Communication Systems functionality makes use of a virtual software service bus that allows communicating subsystems to listen in an asynchronous manner to a wide range of data streams and commands transmitted over the bus, and to respond only where appropriate. Automatic failover switching and other high reliability features are provided through redundant services implemented on disparate servers. Storage is accomplished in compliance with DICOM standards.

### FIELD OF THE INVENTION

This invention relates to medical imaging and information management systems and, more particularly, to distributed processing of medical image information such as radiology and cardiology images using a service bus-based architecture with Workflow management.

### BACKGROUND OF THE INVENTION

Medical imaging systems have become far more sophisticated and complex since first-generation standalone devices. Modern systems include not only a variety of imaging modalities, such as x-ray imaging and computed axial tomography (CAT), but also a variety of processing and distribution options for use once images are acquired. A typical PACS (Picture Archiving and Communication System) or MIIMS (Medical Image and Information Management System) permits images to be transmitted anywhere in the world for purposes of diagnosis, research or archival storage, in a variety of formats.

Advances in teleradiology permit caregivers in one location to communicate with those in other locations to allow remote access to new or baseline images, all to increase the efficiency and effectiveness of patient care.

In many applications, the variety of processing options is increasing to the point where literally dozens of subsystems can communicate with one another to access and process image-related information. From diagnosis to billing to medical records retention, image-related information may find its way to a wide range of the data processing systems of a health facility or network.

To date, system complexity has increased in part because separate mechanisms for communicating data and instructions to these various data processing components are required depending on what is to be done with the image-related information. For example, one aspect of image data processing in accordance with DICOM (Digital Image Communications in Medicine) standards may use a first communications mechanism, while certain archival data transfers may use an entirely separate mechanism. As the variety of processing increases, the different types of communication among related subsystems has likewise become more complicated, with an accompanying risk of problems that could be difficult to identify, locate and resolve.

What is needed, therefore, is a robust mechanism that will allow improved communication among various related imaging subsystems with greater capacity for scaling than would be possible using conventional point-to-point techniques.

Additionally, the image data is compressed/stored and in varying formats and media between these systems.

### SUMMARY OF THE INVENTION

In accordance with the invention, a computer-implemented architecture implementing PACS and MIIMS functionalities makes use of a virtual software “service bus” that allows communicating subsystems to listen in an asynchronous or synchronous manner to a wide range of data streams and commands transmitted over the bus, and to respond only where appropriate based on an integrated workflow rules processor. Additional workflow activities may be generated and orchestrated via the service bus based on the rules processing of the messages on the bus.

In one embodiment, a diagnostic module ignores a message related to archiving of a medical image, while an available archiving server responds to such message and takes over archiving processing for that image via the event-based triggers on the service bus.

An acquisition service acquires DICOM studies from the modalities, stores the studies in DICOM format on a file system, and triggers transactional messaging on the service bus to ensure that the study information is registered both in a local database as well as a main database for all DICOM studies. In one embodiment, registration also includes workflow activations relating to the image acquisition as events based on the acquisition.

A streaming service likewise communicates over the service bus to provide display devices with streamed image information, e.g., for diagnosis by a radiologist.

Another subsystem communicating using the service bus is a permanent storage subsystem for maintaining image information. In one embodiment, a Life Cycle Copying and Management (LCCM) Service keeps a “mirror” copy of DICOM studies on alternate backup systems, and purges/transfers images to other locations at appropriate times, such as when some storage threshold is reached. All of these long-running distributed transactions are orchestrated via the service-bus. This allows for event notification for all sub-systems involved that the orchestrated events occur or not. This aids in the edge “exception case” where all sub-systems need to roll-back the orchestrated long running transaction.

A directory service provides a relational database system to index and track DICOM studies. By utilizing the transactional event-driven service bus, the directory service is always in sync with the distributed data that it is indexing.

A workflow service coordinates and tracks various generalized workflow messages related to operation of the PACS and information system (“system based workflows). A QR-SCU service handles queries for external DICOM studies from foreign PACS that may be available via a network. A QR-SCP service likewise allows foreign DICOM devices to query the system for a patient's DICOM studies.

In other embodiments, various other services communicate asynchronously using the service bus to implement a highly scalable PACS with wide-ranging functionality.

Solution also includes a scheduling service which automates and coordinates the nightly, weekly or monthly. Hourly batch or maintenance procedures required to operate a distributed solution. A typical command scheduled to execute across the distributed components may include operating system level jobs.

Many suitable means for implementing embodiments of the present invention will be apparent in light of this disclosure.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram of a PACS with a service bus-based architecture, configured in accordance with one embodiment of the present invention.

FIG. 2 is a functional block diagram illustrating deployment of a PACS as illustrated in FIG. 1, in accordance with one embodiment of the present invention.

FIG. 3 illustrates distributed processing using a service bus, in accordance with one embodiment of the present invention.

FIG. 4 illustrates a PACS viewer, in accordance with one embodiment of the present invention.

FIG. 5 illustrates streaming service process implementation in accordance with one embodiment of the present invention.

FIG. 6 illustrates database mirroring in accordance with one embodiment of the present invention.

FIG. 7 illustrates image data flow from modality to storage using a service bus, in accordance with one embodiment of the present invention.

FIG. 8 illustrates Q/R SCP service and related processing using a service bus, in accordance with one embodiment of the present invention.

FIG. 9 illustrates use of service bus messages for acquisition service, in accordance with one embodiment of the present invention.

FIG. 10 illustrates use of service bus queues for streaming service, in accordance with one embodiment of the present invention.

FIG. 11 illustrates a dual-server processing configuration, in accordance with one embodiment of the present invention.

FIG. 12 illustrates the configuration of FIG. 11 in the event of a failure of one of the servers.

### DETAILED DESCRIPTION

Disclosed herein is a PACS using a service bus-based architecture to permit asynchronous communications among distributed subsystems. Such architecture permits system scaling using inexpensive, readily-available computing platforms for a variety of imaging support functions.

### General Overview

Legacy approaches to data processing are beginning to give way to new perspectives based on ever-decreasing hardware costs. The cost of data storage has been reduced to a level that distributed storage on small systems is feasible even for Terabytes of data. Network bandwidth is no longer the bottleneck that it historically has been. Accordingly, many functions that used to be limited to specialized hardware are now being deployed on general purpose computing platforms running standard platforms such as .NET (provided by Microsoft) and Java/J2EE (provided by Sun Microsystems). Trailing behind these advances have been corresponding distributed innovations in connecting such functions in a robust and scalable way.

In accordance with the present invention, PACS-related components are implemented using conventional low-cost general-purpose computing systems, which have been adapted to communicate and interoperate with one another via a framework based around a service bus architecture. The design principle of this architecture focuses on availability, performance, reliability/patient safety and automation. Software installed on each physically distributed server node allows each to be configured as a “role” with a particular set of corresponding processes/services and areas of responsibility. Accordingly, various servers provide redundancy for one another and can be called upon to take over for one another should a failure occur. For example, data mirroring is achieved through two separate database partner server instances acting as mirroring partners, with two separate copies of data and near-instantaneous automatic failover.

Likewise, flexibility in operating with a variety of different hardware is achieved through independence of each of the services. In a preferred embodiment, this is achieved by use of a standard driver layer for services to communicate on the service bus.

In a preferred embodiment, centralized configuration management, with a corresponding central configuration database, allows configuration setting and updating in a simple and verifiable manner. Similarly, a “watchdog” utility automates command and control of services management to support fault-tolerance at the client tier, at the middle tier, and at the overall database level.

### System Architecture

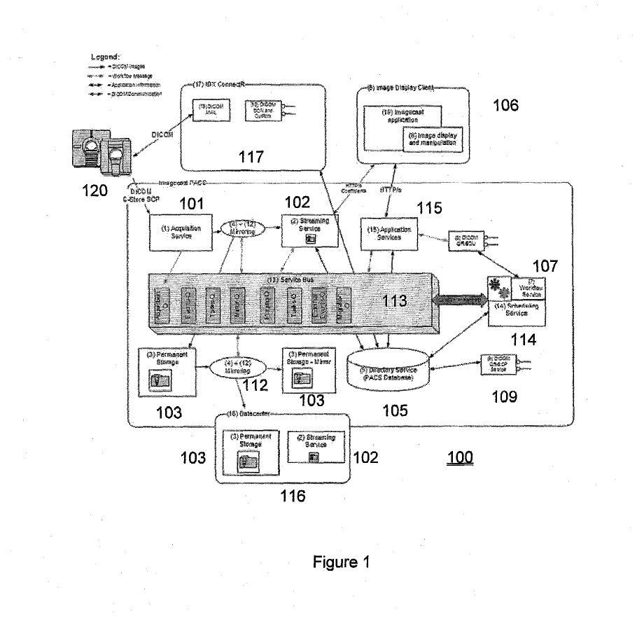

Referring now to FIG. 1, a PACS 100 using a service bus-based architecture is shown. PACS 100 communicates with modalities 120 and corresponding integration tool 117, an image display client 106, and database 116. Modality 120, for instance an X-Ray or MRI device, provides image data both to PACS 100 and an integration tool 117 for interfacing with other systems. In a preferred embodiment, the integration tool 117 is the Connect® product available from IDX Systems/GE Healthcare of Burlington, Vt. Image display client 106 includes an imaging application and an image display/manipulation subsystem discussed in greater detail below.

PACS 100 includes a variety of services for different aspects of operation. Acquisition service 101 obtains DICOM images from modalities 120. Streaming service 102 sends image streams for display client 106 for viewing. Application service 115 includes components to handle DICOM file system I/O, handle localized information indexing, obtain configuration data, and interface with service bus 113. Communication among these various systems/services is accomplished using service bus 113, which serves as a central messaging backbone, allowing asynchronous guaranteed transaction among the various services distributed across PACS 100 and related subsystems. In a preferred embodiment, service bus 113 operates according to service broker t-SQL standards, taking as inputs the various application-services and end-users of PACS 100 and providing as outputs service bus messages for command/control and information. Security is provided by SQL server authentication. The trigger events are application services. Performance counters are integrated SQL Server Service Broker and IDX workflow activation counters.

Workflow service 107 coordinates, tracks and manages all “back-end” workflow messages within PACS 100, and raises triggered events and notifications when failures occur. Workflow service 107 deals with command/control of services, configuration management definitions for services and components, simple CRUD information for relational database 105, workflow controller, and tasks from scheduling service 114. Workflow service 107 operates all communications with PACS components and services via service bus 113, with inputs being service bus scheduling service jobs, end-use tasks via activations, and service bus messages, and outputs being commands on service bus 113. In a preferred embodiment, security is natively provided via the ADO.Net database layer. Triggers are service bus activations and, in some embodiments, appropriate web services. Performance counters are service uptime (time since last service restart) and total service restarts (since last reboot).

Directory service 105 serves as a relational database engine to index and transact information relating to medical images, and in a preferred embodiment operates in accordance with the ANSI SQL-99 standard. It takes as input messages from service bus 113, workflow service 107, scheduling service 114, and application business layers (e.g., IDX Imagecast application business layer via DAL). Security for directory service 105 is provided by service connection to corresponding databases and trusted connections. Directory service 105 is triggered by service bus queue activations. Performance counters for directory service 105 are SQL-server counters, service uptime (time since last service restart), and total service restarts (since last reboot).

DICOM QR-SCU Service 109 serves to query a DICOM archive or other device for study, operating under the Study Root Q/R Information Model—C-MOVE 1.2.840.10008.5.1.4.1.2.2.2 standard. Inputs are workflow service, end user request and outputs are C-MOVE study. Performance counters are service uptime (time since last service restart) and total service restarts (since last reboot).

Permanent storage subsystem 103 represents the components that store medical images permanently on storage media such as magnetic disks. In accordance with a preferred embodiment, storage is accomplished following DICOM Part 10 File standards. Permanent storage subsystem 103 takes as inputs data from streaming service 102 and messages from service bus 113. Security is accomplished through end user authentication tokens; Windows service and file system(s) access to service measures. As illustrated in FIG. 1, permanent storage subsystem 103 is implemented in one embodiment both within PACS 100 and external to it. In some embodiments, additional permanent storage systems 103 may be implemented as required for a particular application.

Mirroring service 112 mirrors DICOM studies to off-site data centers, using DICOM files and Windows file system CIFS standards. In a preferred embodiment, inputs are service bus commands and outputs are file transfers and status messages to service bus 113. Security for mirroring is via ADO.NET connection to service bus 113 and secure file services, and the triggering event is service bus activation of queued message.

Scheduling service 114 passes pre-determined “scheduled” commands onto service bus 113 for a given service or application to perform operations. Inputs are workflow service and human inputs from PACS display console 106. Outputs are service bus commands for the corresponding node/service to execute.

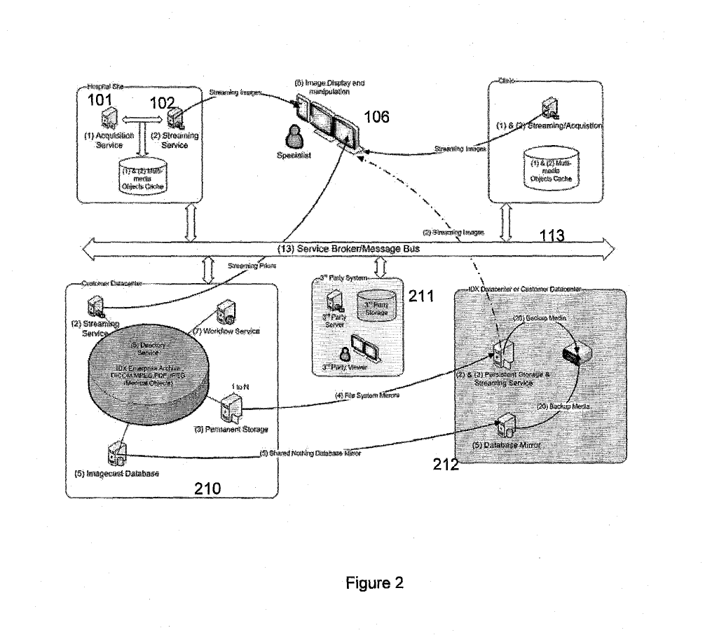

Referring now also to FIG. 2, there is shown a functional view of how service bus 113 functions during operation of PACS 100. A specialist at image display/manipulation subsystem 106 accesses image information at times from, for example, streaming service 102 at a hospital; at other times from streaming or acquisition 101/102 subsystems at a clinic; and still at other times from persistent storage or streaming sources at various data centers. At the same time, data transfers from image sources to image stores are taking place. Service bus 113 facilitates all of this data transfer by sending appropriate messages from appropriate sending nodes to corresponding receiving nodes, e.g., external nodes 210, 211, 212.

Image display/manipulation subsystem 106 is a client application that receives study information from streaming service 102 and displays corresponding images, operating in a preferred embodiment in accordance with DICOM part-10 files system for input/export, DICOM print and DICOM Query/Retrieve (indirect via service bus queue) standards. A human user interface provides inputs, and outputs are DICOM media export CD/DVD-R, DICOM Print, Presentation State, and Annotations data. In a preferred embodiment, performance counters are network quality of service, study/image view timing, total number of errors, total number of logins, number of images viewed and number of images closed prior to full fidelity (which is usable as an indicator of user frustration with performance).

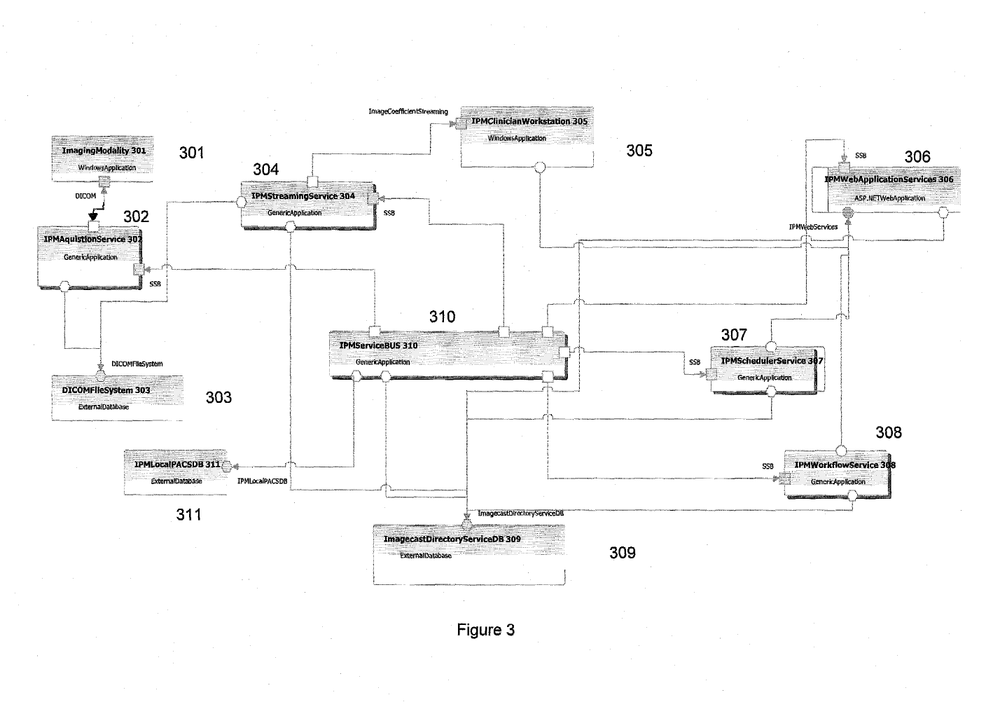

Operation of service bus 113 is illustrated with more specificity in FIG. 3. As illustrated therein, messages communicated through service bus 113 direct various subsystems to send information to others, either directly or via bus 113. In the example of FIG. 3, an imaging modality 301 uses a standard Windows-based software application for communication with an acquisition service 302. Acquisition service 302 acquires DICOM studies from modalities and retrieves relevant DICOM information from the study, series and images and passes this information to service bus 310. In a preferred embodiment, acquisition service 302 includes as inputs DCIOM connection/associations by DICOM SCU devices, and a purge message from service bus 310. Acquisition service 302 provides as outputs DICOM Part-10 studies onto an acquisition service file partition, as well as a study acquisition message to service bus 310. Security for acquisition service 302 is achieved through DICOM AD Title Associations by IP-Address (basic inclusion list of allowed associations), a windows service “run as”, and a security token to communicate over service bus 310. Trigger events for acquisition service 302 are DICOM SCP port-listeners and service startup/shutdown (Windows OS). Performance counters relating to acquisition service 302 are studies acquired/total, images acquired/sec, association connections/total (and per device), association connections/current (ability to see list), rejected associations/total (and per device), cancelled associations/total (and per device), failed associations/total (and per device), max concurrent associations, associations/sec, acquisition bytes/sec, acquisition bytes/total, service uptime (time since last service restart), and total service restarts (since last reboot). Configuration management for acquisition service addresses port, AE-Title, service bus, security authorization token, windows service information, failover node(s), and max concurrent associations information.

Acquisition service 302 communicates directly with DICOM file system 303 (an external database) as well as with a streaming service 304 and service bus 310. Streaming service 304 also communications with service bus 310, as well as with a clinician workstation 305. In accordance with a preferred embodiment, streaming service 304 is configured to respond to a user request for streaming by converting DICOM coefficients (per ICOM Part 10 files) to coefficients used by an end user viewing facility, and then sending the corresponding data to the viewer via HTTP. Thus, it takes as input user requests for study via HTTP interface as well as end-user authorization information, and provides as output HTTP streamed image coefficients. Security is achieved through end user authorization token, windows service, and file system(s) access to service. Performance counters are streamed bytes/sec, streamed bytes total, images viewed total/by modality, average time for image stream/by modality type, streaming errors/total, service uptime (time since last service restart) and total service restarts (since last reboot). Configuration management is achieved through DICOM file system location/mount points, authorization service for end-user tokens, and location for coefficient cache information.

Clinician workstation 305 is in communication with web application services 306, scheduler service 307 and workflow service 308, each of which is also in communication with service bus 310. These services also communicate with directory service 309 and streaming service 304. Directory service 309 and local PACS database 311 also communicate with service bus 310. Accordingly, all of the imaging components in FIG. 3 are able to communicate, either directly or indirectly, with the others using service bus 310.

In operation, historical patient-procedure data is provided to the learning module, which then processes that data into a schema and uses that data to generate prediction models. The historical data comprises actual data from previously completed patient procedures, such as procedure details and attributes, timing for various steps of the procedure (e.g., including registration/intake/admitting processes), patient demographics, patient insurance data, equipment used, attending personnel (e.g., technician that performed procedure and physician that prescribed the procedure), and any other relevant information.

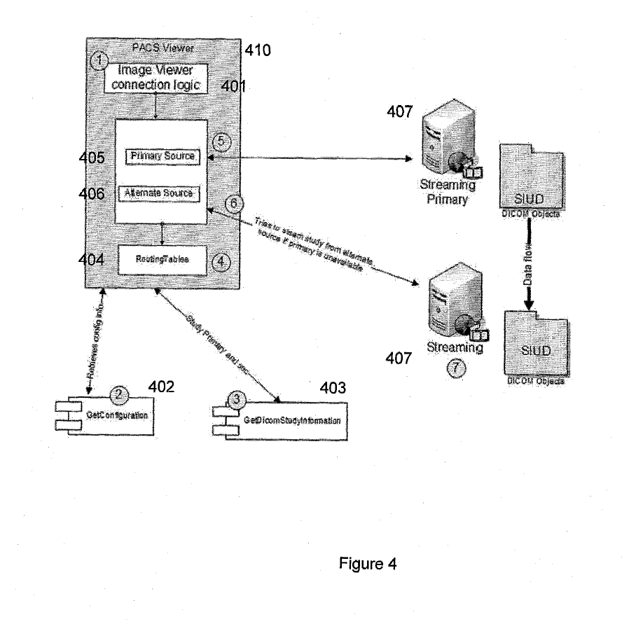

FIG. 4 illustrates an example of operation of a viewer workstation 410 in accordance with a preferred embodiment. In this illustration, a configuration subsystem 402 and a “GetDICOMStudyInformation” subsystem 403 send information to viewer 410 that, when processed by image viewer connection logic 401 and routing tables 404 indicate that a primary source 405 and an alternate source 406 are available for the streaming the requested image study. Accordingly, it does not matter which of the streaming servers 407 is available at the moment, as if one is not available then viewer 410 will simply attempt to get the stream from the other. Thus, the need for specialized and hard to install/support content switch/load balancer subsystems is obviated. In some embodiments, there may be multiple sources available. By getting the appropriate configuration and routing information all potentially available sources of the information will be identified and prepared to serve as a source to viewer 410 should others not be available. Because communications are made using an asynchronous bus structure, each potential server 407 can respond once a request has been issued to identify available servers.

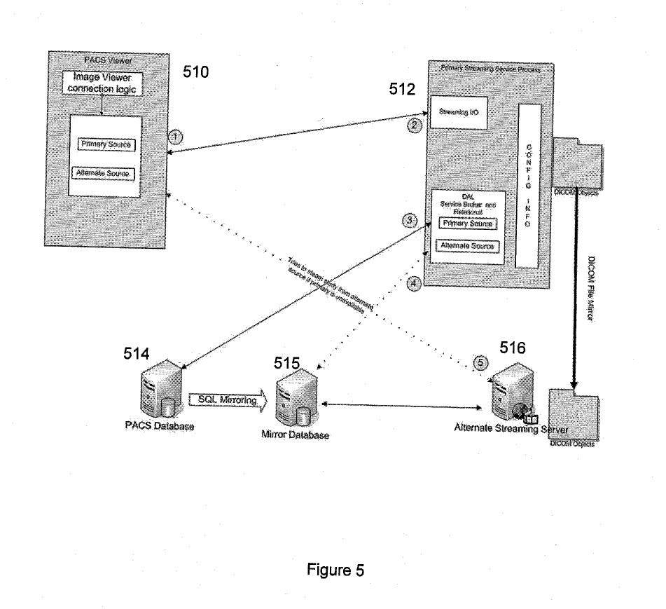

In some applications, high availability of images is a strict requirement. Referring now to FIG. 5, such high availability is achieved by redundancy and failover processing. In this example, a viewer client 510 makes a request for a DICOM study; a primary streaming service 512 provides the data to the viewer 510, accessing it for instance from PACS database 514. Should that database fail, a mirror database 515 provides the same information with very little delay. Failure of streaming service 512 triggers viewer 510 to access the data from an alternate streaming server 516. In accordance with a preferred embodiment, information is stored and accessed using “witness” instances, “principal” instances, and “mirror” instances of databases, where if a principal fails, the mirror takes over as principal and later will flow data to the failed instance to once again make it current.

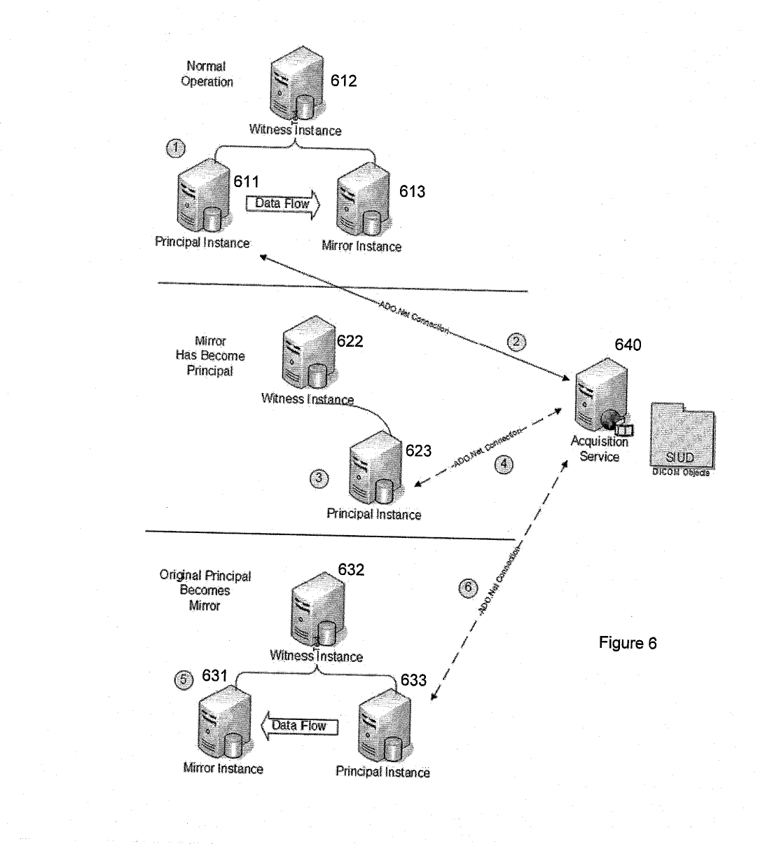

FIG. 6 further illustrates data mirroring in accordance with a preferred embodiment. In normal operation, Acquisition service 640 interacts with principal instance 611, which in turn flows data to mirror instance 613, both in service of witness instance 612. Should principal instance 611 fail, acquisition service 640 begins communicating with what was mirror instance 613, now denoted as principal instance 623, again in service of the witness instance, now referred to as 622. When the failed instance is restored, it now becomes mirror instance 631, with data flow from what is now principal instance 633, again in service of the witness instance, now denoted 632.

### Data Flows

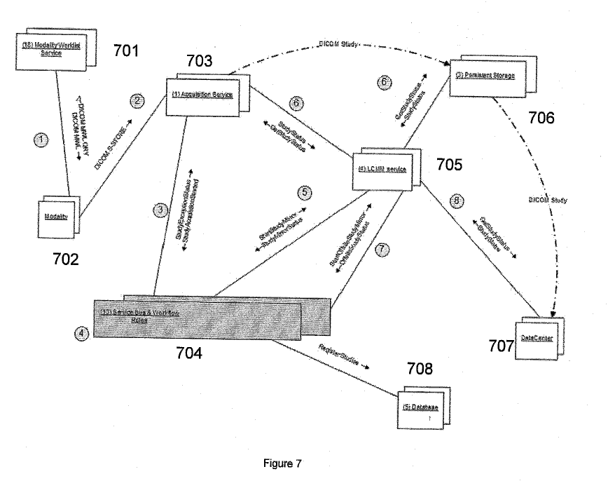

FIG. 7 illustrates the flow of data from a modality to storage using system 100. At the outset, modality 702 queries a modality worklist service 701 for a list of exams to perform. Modality 702 then makes DICOM association and acquisition service 703 performs C-STORE SCP function to transfer images. Asynchronously, acquisition service 703 sends a “study acquisition started” message to service bus 704. As a result, service bus activation registers the study in the database and responds by posting a “study exception status” on the bus for all listeners to see. This message includes indication of success or failure as to whether patient and exam information match. Depending on rules set in configuration, workflow rules processor (shown as part of service bus 704) issues a command to the LCCM service 705 to mirror the study onto a permanent mirror, and depending on configuration, forwarding the study to an external DICOM device or some other external media format. LCCM service 705 performs the copies to persistent storage 706 and reports status back to service bus 704. LCCM does the same with respect to data center 707 and again back to service bus 704 for registration in database 708.

In a preferred embodiment, LCCM service 705 maintains a mirror copy of DICOM studies/images on alternate backup file systems, operating according to Windows CIFS standards. LCCM service 705 accepts as input a service bus message invocation, and provides as output event completion and error messages. Security is achieved through end user authentication tokens, windows service and file system(s) access to service mechanisms. The service 705 is triggered by a workflow event via service bus queue activation. Performance counters for service 705 are images/sec mirrored, re-tries/sec, studies moved, studies to move in queue, Kbytes in queue to move, total failed moves, time since last move (reset to 0 when next move starts as leading indicator of a possible upstream problem), service uptime (time since last service restart) and total service restarts (since last reboot). Configuration management for service 705 is provided by mirror from/to (publisher and subscribers) and security authorization public key.

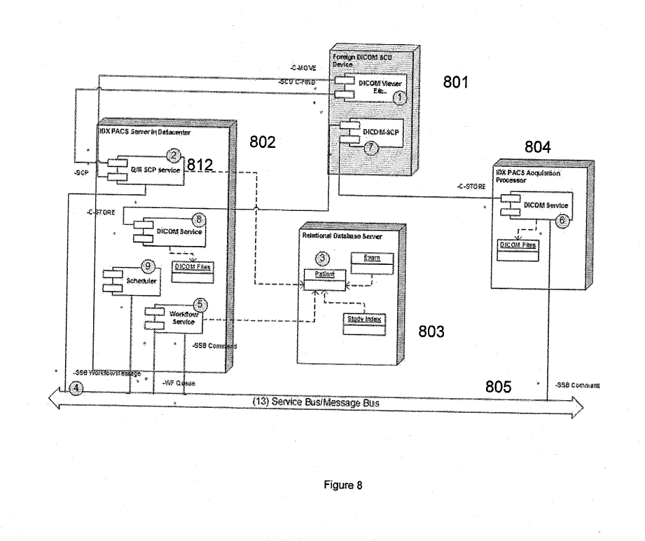

FIG. 8 illustrates data flows for DICOM Query/Retrieve SCP service in accordance with a preferred embodiment. In this example, a “foreign” SCU device, via a DICOM viewer, for example, issues a find request by patient or by study to a Q/R SCP service in a PACS server 802. Once the request is received, the Q/R SCP service 812 queries database 803 for the patient/study information and returns a response. The foreign device 801 then issues a move command to the Q/R SCP service 812 and generates an internal request for action command on service bus 805. Once Q/R service 802 determines a location for the study, it issues a corresponding command on service bus 805 causing DICOM service portion of PACS acquisition processor 804 to initiate a store process back to the foreign device 801. In one embodiment, if more than one study has been requested, more than one DICOM service can issue the move if permitted by the workflow service portion of PACS server 802 and associated rules. Foreign device 801 then receives the study from PACS acquisition processor 804. In one embodiment, a scheduler in PACS server 802 is triggered by the external events to issue appropriate store commands to appropriate DICOM services. Q/R SCP service 812 provides DICOM Query/Retrieve service and allows DICOM Q/R SCU devices to query a patient/study and move at the study level. In a preferred embodiment, Q/R SCP service 812 operates in accordance with the DICOM C-FIND, C-MOVE, patient query find 1.2.840.10008.5.1.4.1.2.1.1, patient query move 1.2.840.10008.5.1.4.1.2.1.2, study query find 1.2.840.10008.5.1.4.1.2.1.1, study query move 1.2.840.10008.5.1.4.1.2.2.2, patient/study only query find 1.2.840.10008.5.1.4.1.2.3.1 and patient/study only query move 1.2.840.10008.5.1.4.1.2.3.2 standards, with DICOM inputs and outputs and IP-address include list (DICOM standard) security. The trigger event for Q/R SCP service 812 is a DICOM SCU device, and the performance counters are service uptime (time since last service restart) and total service restarts (since last reboot).

### Security

To address security concerns inherent in a distributed system, service bus communications with various services use conventional public key certificate security mechanisms, in addition to the specific security mechanisms mentioned elsewhere herein.

### Asynchronous Guaranteed Messaging Using Service Bus

In order to permit the components and subsystems of PACS 101 to be distributed over a wide geographic area, system 101 is based on an architecture that is not reliant on synchronous communications.

Rather, service bus 113 is configured to allow asynchronous queued operation in a manner that guarantees message delivery. Service bus 113 is responsible for “pipeline” data transfers as well as command and control of windows services across the application domain; data storage messages which file into a central OLTP relational database; application logging; movement/tracking of DICOM image mirroring; scheduling engine commands; and queue reader activation (message queued events) which invoke workflow rules.

Service bus 113 is configured to operate with transactionally controlled asynchronous messages. Thus, message receipt is certain. Because relational databases used in system 101 already make use of queues, no additional processing or other overhead is required to deal with issues such as disaster recovery.

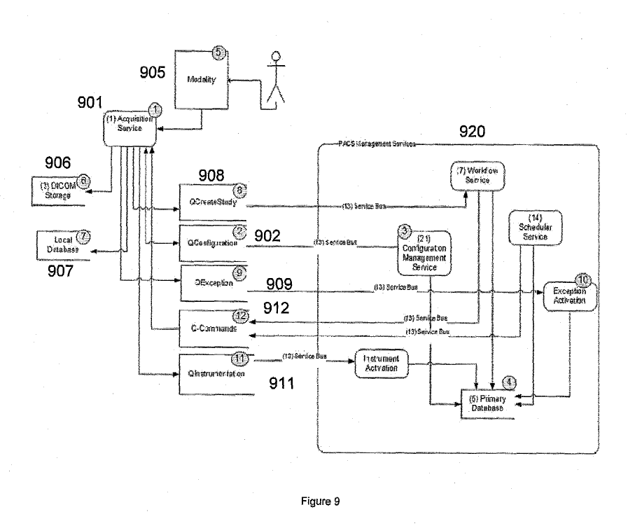

FIG. 9 illustrates acquisition service use of the service bus in accordance with a preferred embodiment. On service startup, and also periodically via polling, acquisition service 901 receives configuration settings from QConfiguration SSB (SQL server service broker) 902, which is the SSB that handles all service configuration information and change management. A configuration management service in PACS management services subsystem 920 handles acquisition service requests. Configuration data for the acquisition service is held in a relational database portion of PACS management services subsystem 920. When a health care provider uses modality 905, the resulting study is sent to acquisition service 901. Acquisition service 901 files the study in local DICOM storage 906, and updates local database 907 with patient/study information for a local index of the information. As part of the same transaction(s), the study information is placed on a QCreateStudy SSB queue 908. Should the study information not match a pre-existing exam/patient or if there are problems with the DICOM study or images, an exception is placed on the QException SSB Queue 909. An exception activation portion of PACS management services subsystem 920 triggers corresponding workflow rules and notifications based on the applicable exception rules. Timing and metrics are captured from the study acquisitions for capacity planning and performance information using SSBs 911 and

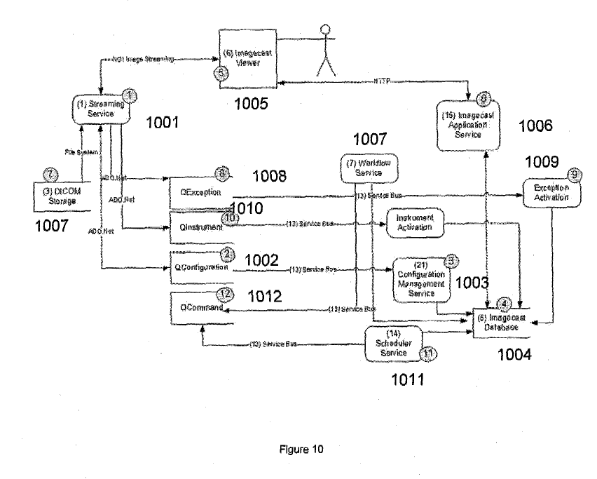

Similarly, FIG. 10 illustrates streaming processing in accordance with a preferred embodiment. On startup, streaming service 1001 requests configuration information and the QConfiguration SSB obtains the information via configuration management service 1003, with such information being stored in database 1004 with other PACS services and application configuration information. After configuration, when an end user at viewer 1005 requests a study (with corresponding worklist and patient/exam information), streaming service 1001 streams the information from DICOM storage 1007. Should an exception occur, the information is sent via the QException SSB 1008 for review, and QException SSB 1008 also generates an “activation” to assert appropriate notifications of the exception. Statistical/performance counter information is logged via QInstrumentation 1010. Scheduler service 1011 activates streaming service 1001 to restart or undertake other (e.g., maintenance) activities and streaming service 1001 receives command and control messages from QCommand SSB 1012.

### DICOM Storage

Three primary components of PACS system 101 are the acquisition service described above, the streaming service described above, and permanent storage. In one embodiment, an NTFS file system is used for storing DICOM studies, with DICOM-compliant lossless compression where possible and “as-received” format where received in a lossy-compressed format. In other embodiments, storage is accomplished using other known techniques. An LCCM service agent working via command and control of a workflow service and the service bus perform the DICOM file movements called for by the mirror, caching and business continuity rules called for under the system's configuration.

In alternate embodiments, a DICOM SCN service provides for integration with third party systems and a cross-enterprise document sharing subsystem provides a standards-based specification for managing the sharing of documents that healthcare enterprises have decided to explicitly share.

### Deployment Architecture

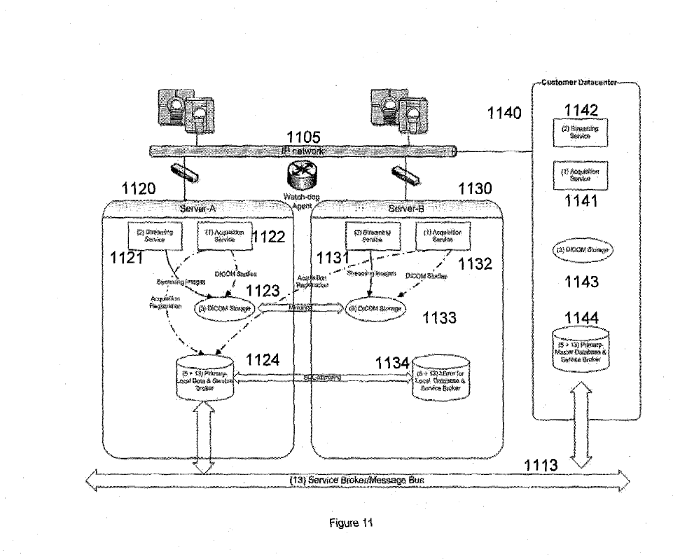

FIG. 11 illustrates an exemplary dual-server configuration for a hospital or clinic. In normal operation, various services 1121-1124 and 1131-1134 are distributed on servers 1120 and 1130 for load balancing and streaming, DICOM studies are mirrored between the servers and a “primary” server is designated for the local relational database for the configuration. Acquisition services 1122/1132 are deployed with their own IP address, and operation of customer datacenter 1140 with services/subsystems 1141-1144 operate as described above using service bus 1113.

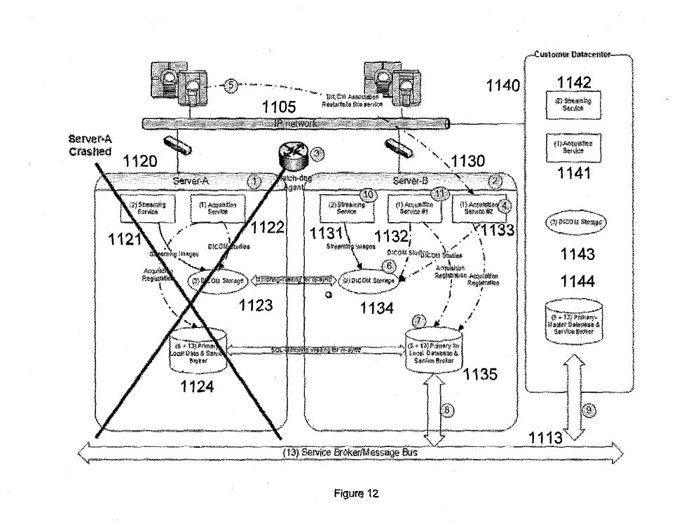

FIG. 12 illustrates operation of the system of FIG. 12 should server 1120 suffer a catastrophic failure, making services/subsystems 1121-1124 unusable. In this instance, Server 1130 services and applications function as normal. The acquisition service 1221 that was running on server 1120 is now started on server 1130 using the same IP address and port. A modality using server 1120 as its DICOM SCP now sends studies to server 1130 without significant interruption or the need for a third party content switch. As a result of the mirroring between servers 1120 and 1130, users can access all studies in the server group even if server 1120 is inoperable. All relational data related to this server group is made available via SQL-Server 2005 mirroring, and all services in the group implement client-side ADO.NET connection failover mirroring support in a preferred embodiment. As service communication is accomplished via service bus 1113 and messages are part of transactional communication, no transactions are lost from the disruption to server 1120. As command and control is centralized on service bus 1113, all communication and study information is known by remaining available nodes and workflow services.

Smaller implementations may involve dual logical servers implemented on a single physical server or, in alternate embodiments, any appropriate mix of existing hardware for the tasks to be accomplished by the system. In one embodiment, a first logical server is designated as primarily for application processing while a second is designated as primarily for image processing, with mirroring and failover capabilities as described above. In yet another embodiment, other physical servers, such as those at remote datacenters, are configured for such failover operation. By use of a service bus for guaranteed asynchronous transactions, high flexibility is possible in selecting which physical machines implement various services and applications.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto

The present invention has been described in terms of specific embodiments incorporating details to facilitate the understanding of the principals of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A distributed computing-implemented method for processing medical image information, comprising:
acquiring the medical image information from a modality;
transmitting transaction data onto a service bus;
selectively receiving the transaction data by services related to the transaction data; and
processing the medical image information responsive to the transaction data.

2. The method of claim 1, further comprising:
storing the medical image information using the service bus for image information transfer.

3. The method in claim 1, establishes workflow characteristics on event driven data across multiple PACS components.

4. The method of claim 1 wherein selectively receiving includes ignoring the transaction data by services not related to the transaction data.

5. The method of claim 1 wherein the processing includes mirroring the medical image information.

6. The method of claim 5 wherein mirroring includes receiving at a first instance in a principal mode and receiving at a second instance in a mirror mode.

7. The method of claim 1 wherein the transmitting is done in an asynchronous manner.

8. The method of claim 2 wherein the storing is accomplished in accordance with DICOM standards.

9. A machine-readable medium encoded with instructions, that when executed by one or more processors, cause the processor to carry out processing of medical image information, comprising: acquiring the medical image information from a modality;
transmitting transaction data onto a service bus;
selectively receiving the transaction data by services related to the transaction data; and
processing the medical image information responsive to the transaction data.

10. The machine-readable medium of claim 9, the processing further comprising:
storing the medical image information using the service bus for image information transfer.

11. The machine-readable medium of claim 9 wherein the processing further comprises:
streaming the medical image information using the service bus for image information transfer.

12. The machine-readable medium of claim 9 wherein selectively receiving includes ignoring the transaction data by services not related to the transaction data.

13. The machine-readable medium of claim 10 wherein the processing includes mirroring the medical image information.

14. The machine-readable medium of claim 13 wherein mirroring includes receiving at a first instance in a principal mode and receiving at a second instance in a mirror mode.

15. The machine-readable medium of claim 9 wherein the transmitting is done in an asynchronous manner.

16. The machine-readable medium of claim 10 wherein the storing is accomplished in accordance with DICOM standards.

17. A system for processing medical image information, comprising:
an acquisition service adapted to acquire the medical image information;
a data storage subsystem; and
a service bus coupling the acquisition service with the data storage subsystem.

18. The system of claim 17, wherein the service bus is configured to provide asynchronous communication between the acquisition service and the data storage subsystem.

19. The system of claim 17, further comprising a display subsystem operatively coupled with the data storage subsystem via the service bus and configured to display the medical image information responsive to transactional communication over the service bus.

20. The system of claim 17, further comprising a display subsystem operatively coupled with the acquisition subsystem via the service bus and configured to display the medical image information responsive to transactional communication over the service bus.
